(19) United States
(12) Patent Application Publication
(10) Pub. No.: US 2014/0353136 A1
(43) Pub. Date: Dec. 4, 2014

(54) HIGH-CURRENT SWITCH

(71) Applicants: Rudolf Von Prondzinski, Gilching (DE); Jens Knebel, Pfaffing (DE)

(72) Inventors: Rudolf Von Prondzinski, Gilching (DE); Jens Knebel, Pfaffing (DE)

(73) Assignee: Schaltbau GmbH, Muenchen (DE)

(21) Appl. No.: 14/358,010

(22) PCT Filed: Aug. 10, 2012
(86) PCT No.: PCT/EP2012/003430

§ 371 Date: Aug. 25, 2014

(30) Foreign Application Priority Data
Nov. 18, 2011 (DE) 102011118894.4

(51) Int. Cl. H01H 1/50; H01H 3/24; H01H 3/40

(52) U.S. Cl. CPC H01H 1/502; H01H 3/40; H01H 3/24; H01H 1/2025
USPC 200/81 R; 200/500

(57) ABSTRACT

Disclosed is a high-current switch comprising a first fixed contact, a second fixed contact spaced apart from the first fixed contact, and at least one contact bridge that is movable relative to the two fixed contacts and an advancing device for transferring the contact bridge from an open position, in which the two fixed contacts are not connected to one another, to a closed position, in which the contact bridge electrically connects the two fixed contacts to one another. The advancing device is configured such that it is non-resilient, the stiffness of the contact bridge and of the advancing device corresponding to a value of at least 50,000 kNmm² in the direction of the pressing force, and the lowest natural frequency of the system, which consists of the contact bridge and the advancing device, being higher than 2,000 Hz in the direction of the pressing force.

This application is a U.S. National Phase under 35 USC 371 of PCT Application No. PCT/EP2012/003430 filed Aug. 10, 2012, which claims priority to German Patent Application No. 10 2011 118 894.4 filed Nov. 18, 2011, the disclosures of which are incorporated by reference herein.

The present invention relates to a high-current switch according to the preamble of the independent claim 1.

A switch of this type comprises a first fixed contact and a second fixed contact spaced apart from the first fixed contact. In addition, a contact bridge that is movable relative to the two fixed contacts and a non-resilient advancing device are provided for transferring the contact bridge from an open position of the switch, in which the two fixed contacts are not connected to one another, to a closed position, in which the contact bridge electrically connects the two fixed contacts to one another. The advancing device is also provided for pressing the contact bridge in the closed position against the two fixed contacts.

Generally, a distinction can be made between two fundamentally different structural designs of switches. According to the first structural design, the contact bridge is moved by means of a suitable advancing device towards the two fixed contacts during the switching operation until the contact surfaces of the fixed contacts and the contact surfaces of the contact bridge come into contact and abut firmly on one another. The contact bridge is normally spring-actuated or even configured as a spring itself. High-current switches operating according to this principle are commercially available. Especially when the contact bridge is configured as a spring, the dimensioning of the contact bridge significantly influences the thermally possible continuous current of the switch. If a short circuit occurs in the switched circuit of these switches, a current with a current strength that is significantly higher than the thermally possible continuous current will flow for a short period of time until the fuse is triggered. In the case of such current surges having a current strength of several kA, opposite magnetic fields, which induce high forces between the fixed contacts and the contact bridge, are generated by the current flow in the area of the contact points. These magnetic forces are directed opposite to the contact pressing force with which the contact bridge is pressed onto the fixed contacts, and, when the current strengths are sufficiently high, they may cause the contact bridge to lift off. This results in the formation of an electric arc between the fixed contact and the contact bridge, through which the fixed contact and the contact bridge are locally heated, which may even result in fusion of the material. If the contact bridge lifts off, the current flowing through the electric arc will be much lower than that flowing in the closed condition of the switch. The lower current flow also leads to a reduction of the magnetically generated lift-off forces, whereby, due to the permanently acting contact pressing force, the switch will be closed again shortly afterwards. This process continues as long as the current surge lasts. The heating of the contact points through the electric arc may result in fusion of the contacts. A particularly critical aspect is the phenomenon of repeated lift-off of the contact bridge in the case of spring-actuated contact bridges and contact bridges that are configured as a spring themselves. If the frequency of the exciting current lies in the range of a natural frequency of the spring, this may result in a resonance disaster, so that the intermittently occurring electric arc will be maintained for a particularly long period of time.

Spring-actuated high-current switches suitable for current surges up to 30 kA are presently commercially available. The limiting factor is, in the final analysis, the contact pressing force which can be accomplished by the spring and through which the contact bridge is pressed onto the two fixed contacts. Such switches are normally switched when they are load-free.

New high-current applications require switches which allow a thermal continuous current of approx. 800 amperes and which are suitable for surge currents up to 85 kA or more than that. These requirements can, for the time being, only be satisfied by so-called blade contact switches. In the case of this second structural design, a contact blade, which is normally wedge-shaped, is pressed into a complementary wedge-shaped reception means of the fixed contact. Blade contact switches are often configured such that the blade, i.e. the contact bridge, is rotatably connected to one of the two fixed contacts and is only pressed into a complementary reception means of the second fixed contact. Blade contact switches are suitable for switching very high thermal continuous currents as well as very high dynamic current surges. The fact that the blade is pressed in during switching on and the contacts are pulled apart during switching off leads to comparatively high wear due to friction. In comparison with switches having the first-mentioned structural design, blade contact switches have a comparatively short service life.

A switch of the type mentioned at the beginning is described in DE 10 2006 008480 B4 as being known from the prior art. This publication also mentions the problem that, in particular in response to high current pulses and the resultant lift-off of the contact bridge, electric arcs may form, which destroy the fixed contacts as well as the movable contact bridge. DE 10 2006 008480 B4 therefore suggests that the contact bridge should be configured as a U-shaped or cup-shaped component, the contact bridge enclosing, in the switched-on condition, extensions of the two fixed contacts projecting therefrom at right angles. The extensions of the two fixed contacts are resilient and, in the switched-on condition, they press from inside to outside against the cup-shaped contact bridge. In the case of this structural design, magnetic fields generated by current pulses increase the contact pressing force between the fixed contacts and the contact bridge. Lift-off of the contact bridge is avoided in this way. The resilient extensions of the two fixed contacts are, however, spread apart outwards in the switched-off condition, so that, during closing and opening of the switch, the contact bridge and the fixed contact extensions are subjected to wear due to friction, which means that the service life of the switch known from DE 10 2006 008480 B4 will be comparatively short.

DE 1540490 A1 discloses a pressure-gas-insulated high-voltage switching system. The mechanism for operating the contact bridge of the switching system is configured like a lifting platform. Operation takes place by means of a spindle drive.

AT 143521 B describes a high-current switch provided with two contact bridges between which the fixed contacts are located. Both contact bridges are equipped with contact pressure springs.

DE 19859199 C1 discloses a disconnecting switch, which also comprises two contact bridges. Also this disconnecting switch is provided with contact pressure springs.

It is therefore the object of the present invention to provide a high-current switch which is suitable for thermal continuous currents of approx. 800 amperes and surge currents of up to approx. 85 kA and which also has a long service life.

This object is achieved by the features of the independent claim 1. According to this claim, the object is achieved in accordance with the present invention, when two movable contact bridges are provided, wherein each of the two fixed contacts is arranged at a respective end of the contact bridges between the two contact bridges, and wherein the advancing device is configured for transferring the two contact bridges from an open position, in which the two fixed contacts are not connected to one another, to a closed position, in which the two fixed contacts are electrically connected to one another by both contact bridges, wherein the contact bridges are pressed by the advancing device against one another onto the fixed contacts in the closed position, wherein the stiffness of the contact bridges and of the advancing device corresponds to a value of at least 50,000 kNmm² in the direction of the pressing force, and wherein the lowest natural frequency of the system, which consists of the contact bridges and the advancing device, is higher than 2,000 Hz in the direction of the pressing force. The contact bridges and the advancing device are thus stiff enough to be able to transmit the necessary high pressing forces, which prevent the contact bridge from lifting off in response to high surge currents of up to approx. 85 kA. The lowest natural frequency of at least 2,000 Hz, which the system consisting of the contact bridges and the advancing device has according to the present invention, guarantees that a resonance disaster will be prevented. Possible excitation frequencies occurring in imaginable cases of use are lower than 2,000 Hz. The system in its entirety, consisting of the contact bridges and the advancing device, is to be considered rigid and consequently non-resilient. This does not mean that individual components of the advancing device and also of the contact bridges, which do not directly participate in force transmission, may not have lower stiffness values. Such components are e.g. washers that may be installed in certain units of the advancing device or of the contact bridge. The high-current switch according to the present invention allows the application of particularly high contact pressing forces.

If a current surge occurs, the connection between the fixed contact and the contact bridge, which is maintained by the pressing force of the advancing device, will be temporally relieved, without the contact bridge being caused to lift off. The fixed contacts and the contact bridge only undergo a slight, temporal deformation. The magnetic forces generated due to the high current strength are absorbed by the contact bridge and the advancing device and fully converted into heat. A particularly great advantage achieved in comparison with conventional blade contact switches is to be seen in the much longer service life of the high-current switch according to the present invention.

Advantageous embodiments of the present invention are the subject matters of the subclaims.

According to a specially preferred embodiment of the present invention, the forces with which the two contact bridges are pressed against the fixed contacts are identical, so that the resultant force acting on the support of the two fixed contacts tends to zero. Therefore, the fixed contacts need not be supported in the housing of the high-current switch in a particularly stable manner. A destruction of the switch due to particularly high contact pressing forces is avoided in this way.

According to a further specially preferred embodiment of the present invention, the advancing device is dimensioned such that, in the closed position, each of the contact bridges is pressed onto the two fixed contacts with a force of at least 500 N. A lift-off of the contact bridge in response to surge currents exceeding 35 kA is thus avoided.

In accordance with another specially preferred embodiment of the present invention, the advancing device comprises a spindle drive for transferring the contact bridges from the open position to the closed position and pressing them, like a screw terminal, onto the fixed contacts. This embodiment allows the application of very high contact pressing forces in combination with a very simple structure of the high-current switch. For generating high contact pressing forces, also a great variety of gear units, e.g. a wedge-type gear or the like, are alternatively imaginable.

Preferably, a spindle of the spindle drive is rotatably supported on a housing of the high-current switch, the spindle being arranged between the two fixed contacts and perpendicular to the longitudinal dimensions of the contact bridges. According to this embodiment, only one spindle is required for generating a uniformly distributed contact pressing force at both fixed contacts. This structure is particularly simple and allows, moreover, production at a reasonable price.

According to another preferred embodiment, the spindle has two threads threaded in opposite directions, each of these oppositely threaded threads being in engagement with one of the two contact bridges. It is thus easily possible to transfer two contact bridges from an open position, in which the two contact bridges are not in contact with the fixed contacts, to a closed position, in which the two contact bridges interconnect the two fixed contacts. The two contact bridges may, for example, move towards one another and towards the fixed contacts when the spindle rotates clockwise, whereas an anti-clockwise rotation of the spindle has the effect that the two contact bridges move away from the fixed contacts.

According to another preferred embodiment, the spindle is supported on the housing such that it is axially displaceable with a certain amount of play. This guarantees that the two contact bridges are pressed uniformly against the fixed contacts. Component tolerances may have the effect that, when the spindle is supported in an axially non-displaceable manner, one of the two contact bridges will arrive earlier at the fixed contacts than the other contact bridge during the switching operation. This would result in a bending moment acting on the fixed contacts, whereby a load would be applied to the supports of the two fixed contacts during each switching operation. This would impair the service life of the switch. The axial play of the spindle must, of course, be smaller than the distance covered by the contact bridges between the open position and the closed position.

According to another preferred embodiment of the present invention, at least one sliding guide is provided between the contact bridge and the housing of the high-current switch. This guarantees that the contact bridges can be closed and opened reliably and without difficulty.

Preferably, the contact bridge comprises on each of its two ends a 90°-offset sliding guide element. This allows extremely accurate guiding of the contact bridge on a respective component of the housing, this embodiment being additionally realizable at a very reasonable price.

According to another preferred embodiment of the present invention, the advancing device is hydraulically driven. The contact pressing forces that can be accomplished by hydraulic means are very high. A hydraulic advancing device is also rigid in the above-specified sense.

In accordance with another preferred embodiment of the present invention, the high-current switch is an AC switch, wherein the lowest natural frequency of the system consisting of the contact bridges and the advancing device is higher than the AC frequency in the direction of the pressing force. When an alternating current of high current strength flows through the high-current switch, AC magnetic fields are generated in the area of the contact between the fixed contacts and the contact bridge, said AC magnetic fields being generated with the frequency of the alternating current. If the AC frequency lies in the range of a resonance frequency of the system consisting of the contact bridges and the advancing device, said system will be caused to oscillate. This may result in a resonance disaster. The consequence would be a periodic lift-off of the contact bridge and the formation of an electric arc between the contact bridge and the fixed contact. If, in accordance with the preferred embodiment, the switch is, however, configured such that the natural frequency of the system consisting of the contact bridges and the advancing device is higher than the AC frequency in the direction of the pressing force, precisely this excitation of oscillations will be avoided.

The contact surfaces of the fixed contacts and of the contact bridges consist preferably of silver. Since silver is very soft, a very good surface contact between the fixed contacts and the contact bridges will be accomplished due to the contact pressing force.

In the following, an embodiment of the present invention will be explained in more detail making reference to the drawings, in which:

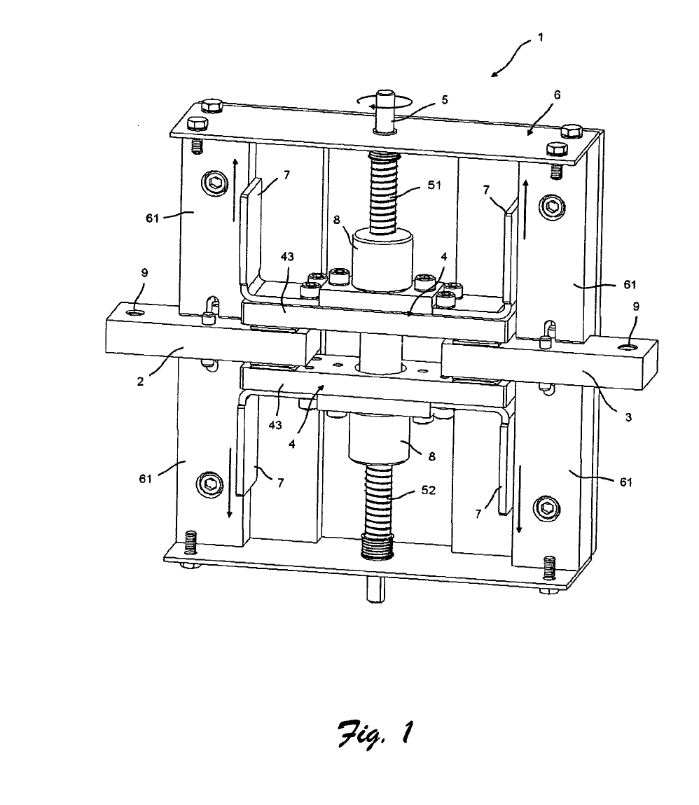

FIG. 1 shows an oblique view of a high-current switch according to the present invention in a closed position, and

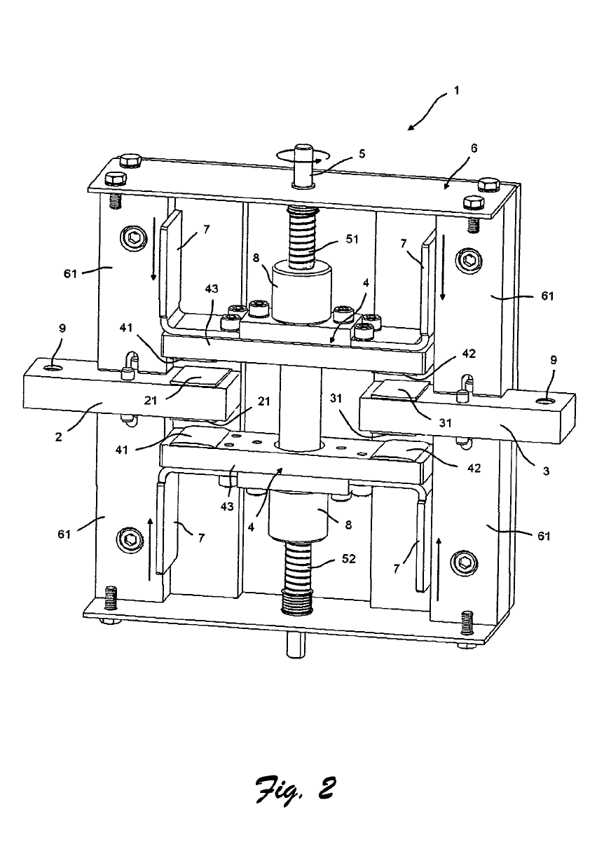

FIG. 2 shows a high-current switch according to the present invention according to FIG. 1 in an open position.

In the statements following hereinbelow like parts are designated by like reference numerals.

FIGS. 1 and 2 show an embodiment of a high-current switch 1 according to the present invention in a closed position (FIG. 1) and in an open position (FIG. 2).

The housing 6 of the high-current switch 1 according to the present invention is shown in a partially open condition so that the interior of the switch can be seen.

The switch comprises a first fixed contact 2 on the left and a second fixed contact 3 on the right. The two fixed contacts 2 and 3 are supported in the housing 6 of the switch 1 in spaced relationship with one another, one end of each of the fixed contacts 2 and 3 projecting beyond the housing 6. On this end a respective electric connection 9 is provided for allowing the switch 1 to be integrated in the electric circuit to be switched.

In the closed position of switch 1 shown in FIG. 1, the two fixed contacts 2 and 3 are electrically connected to each other via the two contact bridges 4. Each of the two contact bridges 4 comprises a rectangular copper bar 43 as a conductor, which has a first contact surface 41 and a second contact surface 42 arranged on its two ends. The contact surfaces 41 and 42 are only identified in FIG. 2. FIG. 2 also shows that the first fixed contact is provided with a respective contact surface 21 on the upper side as well as on the lower side of its end located in the interior of the housing 6. Likewise, also the right, second fixed contact 3 comprises two such contact surfaces 31. In the closed condition of the switch, which is shown in FIG. 1, the first contact surface 41 of the two bridges 4 is in planar contact with a respective contact surface 21 of the first fixed contact 2. The second contact surface 42 of the bridges 4 is in contact with a respective contact surface 31 of the second fixed contact 3.

Perpendicular to the longitudinal direction of the two contact bridges 4, a spindle 5 is arranged centrally between the two fixed contacts 2 and 3, said spindle being rotatably supported on the housing 6. The spindle 5 is provided for the purpose of operating the switch, i.e. for moving the two contact bridges 4 towards the fixed contacts 2 and 3 during switching-on and pressing them against one another onto the fixed contacts 2 and 3 as well as for moving the two contact bridges 4 away from the two fixed contacts 2 and 3 during switching-off. To this end, the spindle 5 comprises two threaded portions 51 and 52, each in engagement with a respective one of the two contact bridges 4 via a nut 8 that is fixedly connected to the contact bridge 4. The two threaded portions 51 and 52 are oppositely threaded, so that an anti-clockwise rotation of the threaded spindle 5 causes the two contact bridges to move towards one another and towards the two fixed contacts 2 and 3. A clockwise rotation of the spindle 5 has the effect that the two contact bridges move away from each other and that the two fixed contacts 2 and 3 are disconnected. For guiding the contact bridges on the housing 6, the contact bridges comprise a respective sliding guide element 7 on each of their two ends. The sliding guide element 7 is a sheet steel component, which is screwed onto the copper bar 43 of the bridge 4 and projects at right angles from the respective end of the contact bridge 4. The projecting leg of the sliding guide element 7 extends thus parallel to the axis of the spindle 5. The projecting legs of the sliding guide elements 7 are guided on slide guide blocks 61 of the housing 6. Also the guide surfaces of the slide blocks 61 extend parallel to the axis of the spindle 5.

Since the direction of movement of the two contact bridges 4 extends perpendicular to the contact surfaces 21 and 31 of the two fixed contacts 2 and 3, no friction or, if at all, only a very low friction will occur between the contact surfaces 41 and 42 of the contact bridges 4 and the contact surfaces 21 and 31 of the fixed contacts 2 and 3 during opening and closing of the switch.

The switch 1 according to the present invention has therefore a much longer service life than comparable blade contact switches. The contact surfaces 21, 31, 41 and 42 are made of silver. Silver is highly conductive and also comparatively soft, whereby excellent contacting is accomplished between the contact bridge and the fixed contact even in the case of minor contact pressing forces.

What is not shown is the drive of the spindle 5, which may e.g. consist of an electric motor. Due to the spindle drive, a high contact pressure, with which the contact bridges 4 are pressed onto the inner ends of the fixed contacts 2 and 3, can be realized even if the engine torque is low. In order to compensate for component tolerances, the threaded spindle 5 is supported such that it is axially displaceable on the housing 6 of the switch 1 with a certain amount of play. The two contact bridges 4 are thus pressed uniformly against the two fixed contacts 2 and 3 in the closed condition of the switch.

1-11. (canceled)

12. A high-current switch (1) comprising a first fixed contact (2), a second fixed contact (3) spaced apart from the first fixed contact, at least one contact bridge (4) that is movable relative to the two fixed contacts, and a non-resilient advancing device for transferring the contact bridge from an open position, in which the two fixed contacts are not connected to one another, to a closed position, in which the contact bridge electrically connects the two fixed contacts to one another, the advancing device being also provided for pressing the contact bridge in the closed position against the two fixed contacts, wherein two movable contact bridges (4) are provided, wherein each of the two fixed contacts is arranged at a respective end of the contact bridges between the two contact bridges, and wherein the advancing device is configured for transferring the two contact bridges from an open position, in which the two fixed contacts are not connected to one another, to a closed position, in which the two fixed contacts are electrically connected to one another by both contact bridges, wherein the contact bridges are pressed by the advancing device against one another onto the fixed contacts in the closed position, wherein the stiffness of the contact bridges and of the advancing device corresponds to a value of at least 50,000 kNmm² in the direction of the pressing force, and wherein the lowest natural frequency of the system, which consists of the contact bridges and the advancing device, is higher than 2,000 Hz in the direction of the pressing force.

13. The high-current switch (1) according to claim 12, wherein the advancing device is dimensioned such that, in the closed position, each of the contact bridges is pressed onto the two fixed contacts with a force of at least 500 N.

14. The high-current switch (1) according to claim 12, wherein the advancing device comprises a spindle drive for transferring the contact bridges from the open position to the closed position and pressing them, like a screw terminal, onto the fixed contacts.

15. The high-current switch (1) according to claim 14, wherein a spindle (5) of the spindle drive is rotatably supported on a housing (6) of the high-current switch (1), the spindle being arranged between the two fixed contacts and perpendicular to the longitudinal dimensions of the contact bridges.

16. The high-current switch (1) according to claim 15, wherein the spindle (5) has two threads (51, 52) threaded in opposite directions, each of these oppositely threaded threads being in engagement with one of the two contact bridges.

17. The high-current switch (1) according to claim 16, wherein the spindle (5) is supported on the housing (6) such that it is axially displaceable with a certain amount of play.

18. The high-current switch (1) according to claim 14, wherein at least one sliding guide is provided between the contact bridge (4) and the housing (6) of the high-current switch (1).

19. The high-current switch (1) according to claim 18, wherein the contact bridge (4) comprises on each of its two ends a 90°-offset sliding guide element (7).

20. The high-current switch (1) according to claim 12, wherein the advancing device is hydraulically driven.

21. The high-current switch (1) according to claim 12, wherein the high-current switch is an AC switch, wherein the lowest natural frequency of the system consisting of the contact bridges and the advancing device is higher than the AC frequency in the direction of the pressing force.
